(19) United States
(12) Patent Application Publication
(10) Pub. No.: US 2014/0249753 A1
(43) Pub. Date: Sep. 4, 2014

(54) Atmospheric Density Correlation Technique

(71) Applicant: Ellen R. Brown, Fredericksburg, VA (US)

(72) Inventor: Ellen R. Brown, Fredericksburg, VA (US)

(73) Assignee: United States Government, as represented by the Secretary of the Navy, Arlington, VA (US)

(21) Appl. No.: 13/783,621

(22) Filed: Mar. 4, 2013

(51) Int. Cl. G01V 99/00; G06F 17/16

(52) U.S. Cl. CPC G01V 99/00; G06F 17/16
USPC 702/2

(57) ABSTRACT

A computer-implemented sequence analysis method is provided for calculating atmospheric density. The method includes determining an altitude Z within an altitude range band such that Z(i)≦Z≦Z(i+1); identifying factor A(i) and exponential B(i) coefficients that correspond to said altitude range; and applying said factor and exponential coefficients to density equation ρ(Z(i)=A(i)e^{R(i)7(i)}, with specified values for the coefficients.

### CROSS REFERENCE TO RELATED APPLICATION

Pursuant to 35 U.S.C. §119, the benefit of priority from provisional application 61/665,366, with a filing date of Jun. 28, 2012, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to computation of atmosphere density. In particular, the invention relates to algorithmic techniques that provide rapid and accurate values corresponding to Standard Atmosphere table&

Calculations related to atmospheric parameters require values of ambient physical properties, typically over a range of altitudes. Such parameters include temperature, pressure and density. The volumes U.S. Standard Atmosphere, 1962 and U.S. Standard Atmosphere, 1976 represent accepted references for atmospheric density calculations since publication. U.S. Standard Atmosphere, 1976 is available at http://www.chet-aero.com/download/US-Std-Atmosphere.pdf (as a 15 MB file) and at http://ntrs.nasa.gov/archive/nasa/casi.ntrs.nasa.gov/19770009539_{—}197700953 9.pdf (as a 17 MB file). Such calculations can be used in a variety of aeronautical contexts, such as for predictions in aeroheating response, trajectory accuracy, etc.

The 1962 and 1976 versions employ the same set of formulas from geopotential height from 0 km to 170 km. However, the defining set of temperatures used by these formulas differs above geopotential height of about 51 km. Standard, 1976 provides tables for pressure, temperature and density for both geopotential and geometric heights. Geopotential height or elevation, expressed as H, denotes elevation levels having uniform potential energy that varies due to local variations in gravitational acceleration, such as from changes in latitude. By contrast, more conventionally recognized geometric height or altitude, expressed as Z, denotes vertical distance above mean sea level. Geopotential height has been defined in terms of geometric height by:

$$H ≡ \frac{1}{{g}_{0}} {\int }_{0}^{Z} g d Z , \qquad ( 1 )$$

where reference gravitational acceleration g₀ at mean sea level (MSL) is defined as 9.80665 m/s² and local gravitational acceleration g varies with geometric altitude Z. For conversion, the relation between geopotential and geometric heights can be described for reference gravitational acceleration as:

$$Z ≅ \frac{{r}_{0 } H}{{r}_{0} - H} , \qquad ( 2 )$$

where r₀ is effective earth's radius of 6356.766 km corresponding to latitude 45.452°. Generally, geometric height has a slightly higher value than geopotential height. For example, geometric altitude of 100 km corresponds to geopotential altitude of 98.451 km.

### SUMMARY

Conventional techniques for calculating density as a function of altitude yield disadvantages addressed by various exemplary embodiments of the present invention. In particular, various exemplary embodiments provide a computer-implemented sequence analysis method for calculating atmospheric density. The method includes determining an altitude Z within an altitude range band such that Z(i)≦Z≦Z(i+1); identifying factor A(i) and exponential B(i) coefficients that correspond to said altitude range; and applying said factor and exponential coefficients to density equation ρ(Z(i))=A(i)e^{B(i)Z(i)}, with specified values for the coefficients.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a graphical view of density from the Standard Atmosphere, 1976;

FIG. 2 is a graphical view of density difference comparison;

FIG. 3 is a graphical view of factor coefficients;

FIG. 4 is a graphical view of exponential coefficients; and

FIG. 5 is a tabular view of exemplary factor and exponential coefficients.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized; and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

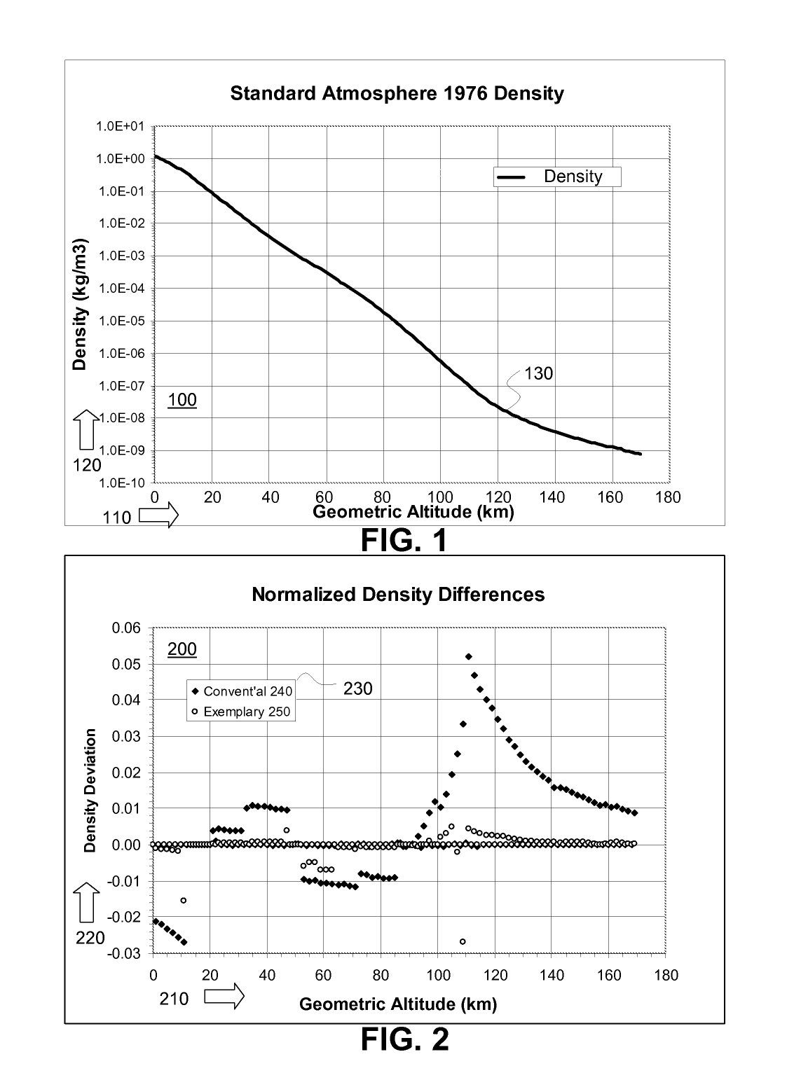

Air density is a continuous function of altitude. FIG. 1 shows a graphical view 100 of atmospheric density from the 1976 Standard Atmosphere. The linear abscissa 110 denotes geometric altitude in kilometers and the logarithmic ordinate 120 denotes density in kilograms-per-cubic-meter (kg/m³). The values are presented as a curve 130 that decreases exponentially with increasing altitude from mean sea level (MSL).

Select computer models, such as for nuclear fratricide, employ atmospheric density calculations, including values available in the Standard Atmosphere volumes. Due to the nonlinear complexity of the formula in these references, codes written to include such calculations remain computationally intense. Consequently, the original versions of the model codes incorporated approximations to facilitate rapid calculation for the atmospheric density. However, the conventional method most similar to the exemplary embodiments nonetheless produces discontinuities every two kilometers.

Various exemplary embodiments provide continuous value for density as a function of altitude, and very closely match the values presented in the Standard Atmosphere volumes. Exemplary embodiments can be applied to either set of defining temperatures, and can therefore accurately represent densities for either the 1962 or 1976 versions of Standard Atmosphere.

To ensure continuity and match the Standard Atmosphere density values within the interval, exemplary embodiments pre-compute two constant tables for coefficients A(i) and B(i). Because the values in these tables are then stored in a look-up table, there is a reduction in the amount of computational time required to compute density when many values at many altitudes are required (for example, in trajectory calculations). The form for density ρ at geometric altitude Z can be expressed as:

ρ(Z)=A(i)e^{B(i)Z}. (3)

At small enough altitude intervals, isothermal conditions can be assumed, such that temperature T can be treated as constant at the geometric altitude interval Z(i)≦Z≦Z(i+1) between lower (i) and upper (i+1) intervals. This means the temperature changes within the interval can be neglected, so the general form of eqn. (3) can be used to simplify calculations. This involves rewriting the expression multiplying by unity as:

ρ(Z)=A(i)e^{B(i)Z}e^{-B(i)Z(i)}e^{B(o)Z(i)}. (4)

Re-organizing the terms in eqn. (4) yields:

ρ(Z)=A(i)e^{B(i)Z(i)}e^{B(i)(Z-Z(i))}=A(i)e^{B(i)Z(i)}e^{B(i)ΔZ}, (5)

where the natural number is raised to the values shown,

ΔZ=Z(i+1)−Z(i). (6)

Exemplary embodiments generate the coefficients A(i) and B(i), such as for an interval of geometric altitude ΔZ chosen by an analyst. (The isothermal approximation works very well at intervals less than or equal to two kilometers (2 km), but the value of ΔZ can be changed depending on where in the atmosphere the calculations need to be conducted. This interval can also change for solutions in which looser tolerances are acceptable with respect to values in the Standard Atmosphere volumes, e.g., intervals of 5 km.

The Standard Atmosphere formulas employ geopotential altitude. However, a geometric altitude may be substituted if the results are sufficiently accurate for the analysis in question. From eqn. (3), the altitude where Z=Z(i) the density can be expressed as:

ρ(Z(i)=A(i)e^{B(i)Z(i)}. (7)

Similarly, at the attitude where Z=Z(i+1) the density represents:

ρ(Z(i +1))=A(i+1)e^{B(i+1)Z(i+1)}. (8)

Exemplary embodiments fix a density at each level (i) and compute A and B coefficients that maintain validity within the interval Z(i)≦Z≦Z(i+1) . The value at Z=Z(i+1) cannot be obtained from the values of A and B at the previous level (i). The factor coefficient A has units of density, or kg/m³, while the exponential coefficient B is dimensionless. Conventional methods employ different values for A and B than for exemplary embodiments. The conventional methods produce less accuracy inside the interval (as well as at the upper end of the interval near (i+1) than the exemplary values disclosed herein.

The conventional method requires an artificial reset at each new Z(i+1); i.e., the density that is computed at Z(i+1) using the earlier values of A(i) and B(i) deviates substantially compared to the values provided in the Standard Atmosphere volumes. That is, as the value of Z increases within the interval, the difference in densities between older method and the Standard Atmosphere values increases. From eqn. (2), one can define that:

Z=Z(i+1). (9)

then from eqn. (9) the density relation obtains:

ρ(Z(i)=A(i)e^{B(i)Z(i)}e^{B(i)ΔZ}. (10)

Further simplification provides:

ρ(Z(i +1))=ρ(Z(i)e^{B(i)ΔZ} (11)

This explicitly provides continuity on the interval boundary. Solutions of eqn. (11) for B(i) and A(i) provide formulas needed for the density calculation that can be accomplished using eqn. (8). Solving for B(i) provides:

$$B ( i ) = \frac{1}{Δ Z} ln ( \frac{ρ ( Z ( i + 1 ) )}{ρ ( Z ( i ) )} ) . \qquad ( 12 )$$

### Solving for A(i),

A(i)=ρ(Z(i)e^{-B(i)Z(i)}. (13)

Note that the definition for coefficients A and B enforce continuity because values at interval (i+1) are computed from values at interval (i). The procedure has greatest accuracy when density ρ at geometric height Z employs tabular look-up values for A(i) and B(i) such that Z(i)≦Z≦Z(i+1). This serves to reproduce results from the Standard Atmosphere volumes.

Conventional coefficients for eqn. (3) produce density values with non-dimensional errors of up to about ±0.5, whereas exemplary coefficients, reduce these non-dimensional errors to no more than about ±0.07 or less. These normalized density deviations ε(i) constitute the difference between calculated and standard density values divided by the standard density, also expressible as:

$$ɛ ( i ) = \frac{{ρ}_{calc} ( Z ( i ) ) - {ρ}_{std 76} ( Z ( i ) )}{{ρ}_{std 76} ( Z ( i ) )} , \qquad ( 14 )$$

where ρ_{calc} represents calculated density value from eqn. (3), and ρᵢₙₜₗ₇₆ represents the tabular value of the Standard Atmosphere 1976 density value at the altitude band denoted by altitude Z(i).

FIG. 2 shows a graphical view 200 of normalized density deviation e(i) from the Standard Atmosphere 1976, comparing conventional tabular form to exemplary embodiments over the geometric altitude range. The abscissa 210 denotes geometric altitude in kilometers and the ordinate 220 denotes non-dimensional density deviation. A legend 230 identifies symbols for the conventional 240 (solid diamond) and the exemplary 250 (hollow circle). As can be observed, the discrepancy for the exemplary coefficients is about an order of magnitude less than the corresponding discrepancy for conventional coefficients.

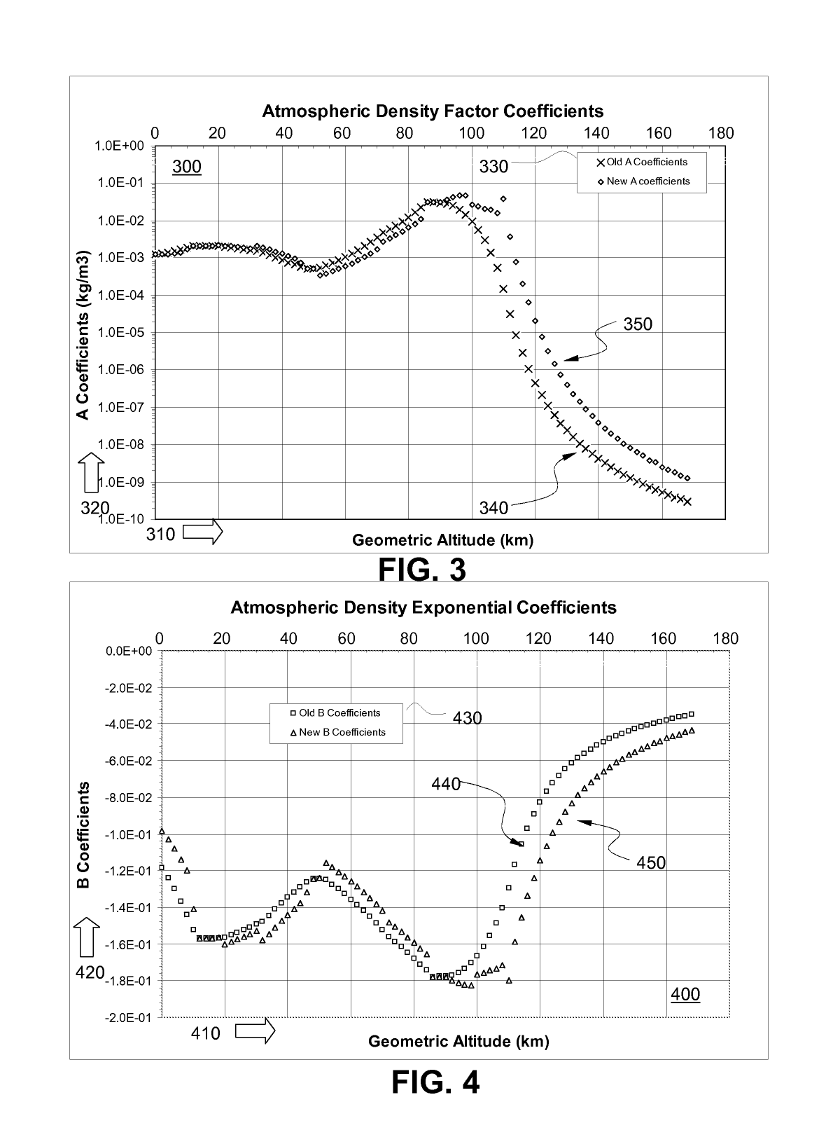

Developing these values for purposes of improving the accuracy of density calculations has constituted a concerted challenge. FIG. 3 shows a graphical view 300 comparing conventional and exemplary values of the factor coefficients A(i) with respect to geometric altitude. The abscissa 310 denotes geometric altitude in kilometers and the ordinate 320 denotes the factor coefficient in density units. A legend 330 identifies symbols for the conventional 340 (diagonal cross) and the exemplary 350 (hollow diamond). The differences become most pronounced at the higher altitudes.

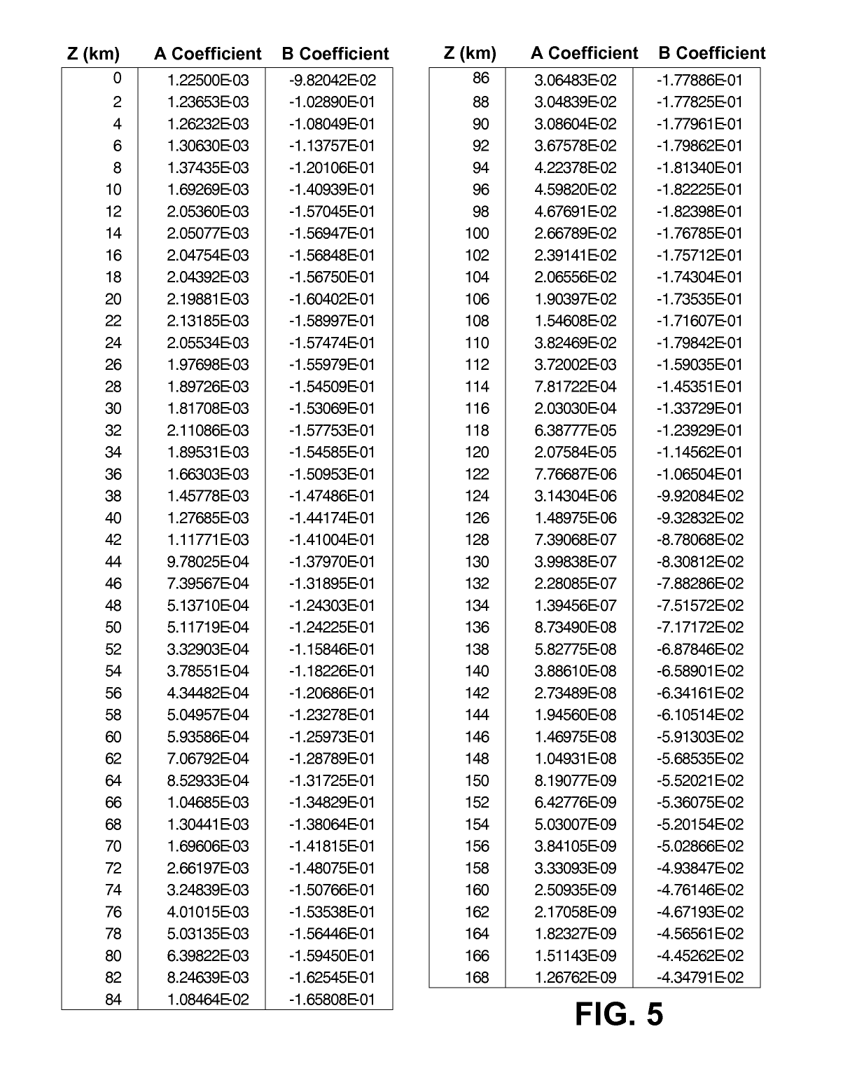

FIG. 4 shows a graphical view 400 comparing conventional and exemplary values of the exponential coefficients B(i) with respect to geometric altitude. The abscissa 410 denotes geometric altitude in kilometers and the ordinate 420 denotes the non-dimensional exponential coefficient. A legend 430 identifies symbols for the conventional 440 (hollow square) and the exemplary 450 (hollow triangle). FIG. 5 shows a tabular listing of the factor A(i) and exponential B(i) coefficients with respect to geometric altitude Z(i). These values constitute the substantial basis for the exemplary embodiments.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented sequence analysis method for calculating atmospheric density, said method comprising:
determining a geopotential altitude Z within an altitude range band such that Z(i)≦Z≦Z(i+1) between intervals and i+1;
identifying factor A(i) and exponential B(i) coefficients that correspond to said altitude range; and
applying said factor and exponential coefficients to density equation:
ρ(Z(i))=A(i)e^{B(i)Z(i)}, wherein
ρZ(i)) is the atmospheric density for the altitude Z(i), and values for said factor and exponential coefficients correspond to a table:

| Z (km) | A coefficient | B coefficient |
|---|---|---|
| 0 | 1.22500E−03 | −9.82042E−02 |
| 2 | 1.23653E−03 | −1.02890E−01 |
| 4 | 1.26232E−03 | −1.08049E−01 |
| 6 | 1.30630E−03 | −1.13757E−01 |
| 8 | 1.37435E−03 | −1.20106E−01 |
| 10 | 1.69269E−03 | −1.40939E−01 |
| 12 | 2.05360E−03 | −1.57045E−01 |
| 14 | 2.05077E−03 | −1.56947E−01 |
| 16 | 2.04754E−03 | −1.56848E−01 |
| 18 | 2.04392E−03 | −1.56750E−01 |
| 20 | 2.19881E−03 | −1.60402E−01 |
| 22 | 2.13185E−03 | −1.58997E−01 |
| 24 | 2.05534E−03 | −1.57474E−01 |
| 26 | 1.97698E−03 | −1.55979E−01 |
| 28 | 1.89726E−03 | −1.54509E−01 |
| 30 | 1.81708E−03 | −1.53069E−01 |
| 32 | 2.11086E−03 | −1.57753E−01 |
| 34 | 1.89531E−03 | −1.54585E−01 |
| 36 | 1.66303E−03 | −1.50953E−01 |
| 38 | 1.45778E−03 | −1.47486E−01 |
| 40 | 1.27685E−03 | −1.44174E−01 |
| 42 | 1.11771E−03 | −1.41004E−01 |
| 44 | 9.78025E−04 | −1.37970E−01 |
| 46 | 7.39567E−04 | −1.31895E−01 |
| 48 | 5.13710E−04 | −1.24303E−01 |
| 50 | 5.11719E−04 | −1.24225E−01 |
| 52 | 3.32903E−04 | −1.15846E−01 |
| 54 | 3.78551E−04 | −1.18226E−01 |
| 56 | 4.34482E−04 | −1.20686E−01 |
| 58 | 5.04957E−04 | −1.23278E−01 |
| 60 | 5.93586E−04 | −1.25973E−01 |
| 62 | 7.06792E−04 | −1.28789E−01 |
| 64 | 8.52933E−04 | −1.31725E−01 |
| 66 | 1.04685E−03 | −1.34829E−01 |
| 68 | 1.30441E−03 | −1.38064E−01 |
| 70 | 1.69606E−03 | −1.41815E−01 |
| 72 | 2.66197E−03 | −1.48075E−01 |
| 74 | 3.24839E−03 | −1.50766E−01 |
| 76 | 4.01015E−03 | −1.53538E−01 |
| 78 | 5.03135E−03 | −1.56446E−01 |
| 80 | 6.39822E−03 | −1.59450E−01 |
| 82 | 8.24639E−03 | −1.62545E−01 |
| 84 | 1.08464E−02 | −1.65808E−01 |
| 86 | 3.06483E−02 | −1.77886E−01 |
| 88 | 3.04839E−02 | −1.77825E−01 |
| 90 | 3.08604E−02 | −1.77961E−01 |
| 92 | 3.67578E−02 | −1.79862E−01 |
| 94 | 4.22378E−02 | −1.81340E−01 |
| 96 | 4.59820E−02 | −1.82225E−01 |
| 98 | 4.67691E−02 | −1.82398E−01 |
| 100 | 2.66789E−02 | −1.76785E−01 |
| 102 | 2.39141E−02 | −1.75712E−01 |
| 104 | 2.06556E−02 | −1.74304E−01 |
| 106 | 1.90397E−02 | −1.73535E−01 |
| 108 | 1.54608E−02 | −1.71607E−01 |
| 110 | 3.82469E−02 | −1.79842E−01 |
| 112 | 3.72002E−03 | −1.59035E−01 |
| 114 | 7.81722E−04 | −1.45351E−01 |
| 116 | 2.03030E−04 | −1.33729E−01 |
| 118 | 6.38777E−05 | −1.23929E−01 |
| 120 | 2.07584E−05 | −1.14562E−01 |
| 122 | 7.76687E−06 | −1.06504E−01 |
| 124 | 3.14304E−06 | −9.92084E−02 |
| 126 | 1.48975E−06 | −9.32832E−02 |
| 128 | 7.39068E−07 | −8.78068E−02 |
| 130 | 3.99838E−07 | −8.30812E−02 |
| 132 | 2.28085E−07 | −7.88286E−02 |
| 134 | 1.39456E−07 | −7.51572E−02 |
| 136 | 8.73490E−08 | −7.17172E−02 |
| 138 | 5.82775E−08 | −6.87846E−02 |
| 140 | 3.88610E−08 | −6.58901E−02 |
| 142 | 2.73489E−08 | −6.34161E−02 |
| 144 | 1.94560E−08 | −6.10514E−02 |
| 146 | 1.46975E−08 | −5.91303E−02 |
| 148 | 1.04931E−08 | −5.68535E−02 |
| 150 | 8.19077E−09 | −5.52021E−02 |
| 152 | 6.42776E−09 | −5.36075E−02 |
| 154 | 5.03007E−09 | −5.20154E−02 |
| 156 | 3.84105E−09 | −5.02866E−02 |
| 158 | 3.33093E−09 | −4.93847E−02 |
| 160 | 2.50935E−09 | −4.76146E−02 |
| 162 | 2.17058E−09 | −4.67193E−02 |
| 164 | 1.82327E−09 | −4.56561E−02 |
| 166 | 1.51143E−09 | −4.45262E−02 |
| 168 | 1.26762E−09 | −4.34791E−02 |

such that said altitude Z has length units of kilometers and said identifying factor A has density units of kilograms-per-cubic-meter.

2. The method according to claim 1, wherein said density equation is interpolated within said altitude range band between Z(i) and Z(i+1).
